(19) United States
(12) Patent Application Publication
(10) Pub. No.: US 2025/0172929 A1
(43) Pub. Date: May 29, 2025

(54) METHOD FOR SYNCHRONIZING TIME SERIES OF SENSOR VALUES RELATING TO A MANUFACTURING PROCESS

(71) Applicant: Robert Bosch GmbH, Stuttgart (DE)

(72) Inventors: Johannes Haug, Rottenburg (DE); Timo Pfrommer, Stuttgart (DE)

(21) Appl. No.: 18/948,898

(22) Filed: Nov. 15, 2024

(30) Foreign Application Priority Data
Nov. 29, 2023 (DE) 10 2023 211 939.0

(51) Int. Cl. G05B 23/02; G05B 19/418

(52) U.S. Cl. CPC G05B 23/0221; G05B 19/41875

(57) ABSTRACT

A method for synchronizing time series of sensor values relating to a manufacturing process. The method includes: detecting at least two time series of sensor values by the same sensor during each of at least two executions of the manufacturing process; ascertaining, for each of the at least two time series of sensor values, deviations of different points of the corresponding time series from corresponding points of a reference time series and shifting the corresponding time series by a value ascertained based on the ascertained deviations, in order to synchronize the time series; and providing the synchronized time series.

### FIELD

The present invention relates to a method for synchronizing time series of sensor values relating to a manufacturing process, which method can be used to synchronize time series of sensor values relating to the manufacturing process in a simple and intuitive manner.

### BACKGROUND INFORMATION

The term “manufacturing process” or “production process” is understood to mean a standardized workflow, i.e., one that meets certain requirements, for the production or manufacture of a product, such as a semiconductor module. The production process includes predefined production methods as well as work and operating resources, so that a saleable product is produced, in particular through mechanical machining and processing.

As part of quality assurance during a manufacturing process, products produced through the manufacturing process are usually subjected to an inspection after the actual manufacture to check for the presence of deviations from the norm or anomalies. Based on this inspection, it can subsequently be decided, for example, whether the product in question should be further processed or used without additional effort or whether it should be scrapped or disposed of, for example in order to avoid safety risks when the object is subsequently used.

Anomalies are understood to be abnormalities or irregularities or deviations from a given norm, for example scratches on the surface of a manufactured component or unwanted gaps or openings between individual parts of the object.

Such anomalies can, for example, be identified on the basis of sensor values relating to the manufacturing process, i.e., sensor values detected during executions of the manufacturing process or the manufacture of products through the manufacturing process, or corresponding time series of sensor values, i.e., corresponding series of consecutively detected sensor values. A disadvantage, however, is that such time series of sensor values are often shifted in relation to one another, i.e., characteristic points in time during a repeatable manufacturing process may occur at different points in time in different time series of sensor values and may not be identical. Consequently, the individual time series of sensor values must be synchronized before they are evaluated, in particular before they are used for anomaly detection.

Germany Patent No. DE 10 2019 216 517 B3 describes a method for synchronizing a plurality of sensor systems with respect to a particular phase for providing data, wherein the sensor systems each provide the data periodically, wherein a phase requirement is generated by at least one evaluation component for each of the plurality of sensor systems, wherein the at least one evaluation component is configured to receive the data of the plurality of sensor systems, all phase requirements are checked for executability, target phase requirements are generated if the phase requirements have been verified as executable, and the particular target phase requirements are transmitted to the particular sensor systems, for synchronizing the phases of the plurality of different sensor systems.

An object of the present invention is to provide an improved method for synchronizing time series of sensor values relating to a manufacturing process.

The object may be achieved by a method for synchronizing time series of sensor values relating to a manufacturing process according to certain features of the present invention.

The object may also achieved by a system for synchronizing time series of sensor values relating to a manufacturing process according to certain features of the present invention.

### SUMMARY

According to one example embodiment of the present invention, th object may be achieved by a method for synchronizing time series of sensor values relating to a manufacturing process, wherein the method comprises detecting a time series of sensor values by the same sensor during each of at least two executions of the manufacturing process, ascertaining, for each of the at least two time series of sensor values, deviations of different points of the corresponding time series from corresponding points of a reference time series and shifting the corresponding time series by a value ascertained based on the ascertained deviation, in order to synchronize the time series, and providing the synchronized time series.

A sensor, which is also referred to as a detector, (measured variable or measuring) pickup or (measuring) probe, is a technical component which can detect certain physical or chemical properties and/or the material nature of its surroundings qualitatively or quantitatively as a measured variable.

A reference time series is understood to be a time series of reference values or a comparison time series. Deviations of different points of the corresponding time series from corresponding points of a reference time series and shifting the corresponding time series means that, in each case, deviations or differences between characteristic points in time during the manufacturing process within or on the corresponding time series and the corresponding point in time within or on the reference time series are ascertained.

Such a method has the advantage that time series of sensor values relating to the manufacturing process can be synchronized in a simple and intuitive manner. In particular, the time series can be synchronized based on a non-invasive method, especially since the individual time series are only shifted by a certain value, i.e., the sensor values are hardly changed and the characteristic of the corresponding time series is substantially retained. In addition, it is not necessary to define hyperparameters or configuration parameters.

Overall, an improved method for synchronizing time series of sensor values relating to a manufacturing process is thus provided.

According to an example embodiment of the present invention, the step of ascertaining, for each of the at least two time series of sensor values, deviations of different points of the corresponding time series from corresponding points of a reference time series and shifting the corresponding time series by a value ascertained based on the ascertained deviation, in order to synchronize the time series, can comprise applying a dynamic time warping algorithm.

Dynamic time normalization or dynamic time warping refers to an algorithm that maps sequences of values of different lengths to one another.

In this way, comparatively accurate results can be automatically achieved in a simple manner, without the need for resource-intensive adjustments.

In one example embodiment of the present invention, the method furthermore comprises a step of approximating the reference time series based on training data of the dynamic time warping algorithm.

The reference time series being approximated based on the at least two time series of sensor values means that the reference time series is ascertained or estimated based on the at least two time series of sensor values.

The reference time series can thus be derived in a simple manner based on known values, without the need for complex and resource-intensive adjustments.

However, the reference time series being approximated based on the training data of the dynamic time warping algorithm is only one possible embodiment. Rather, the reference time series may, for example, also be defined by process experts.

Furthermore, according to an example embodiment of the present invention, the step of ascertaining, for each of the at least two time series of sensor values, deviations of different points of the corresponding time series from corresponding points of a reference time series and shifting the corresponding time series by a value ascertained or derived based on the ascertained deviations, can comprise disregarding sensor values that are outside a specified value range. As a result, it can be ensured that the synchronization is not distorted by outliers in the sensor values and is instead based on the relevant sensor values.

The specified value range in this respect may, for example, be specified by a process expert.

In addition, according to an example embodiment of the present invention, the step of ascertaining, for each of the at least two time series of sensor values, deviations of different points of the corresponding time series from corresponding points of a reference time series and shifting the corresponding time series based on a value ascertained based on the ascertained deviations, can comprise disregarding sensor values that have a distance from the reference curve that is greater than a threshold value for the distance, when shifting the corresponding time series. As a result, the value by which a time series can be maximally shifted can be defined by a user and/or process expert who specifies the threshold.

A further example embodiment of the present invention also provides a method for recognizing anomalies in products produced through a manufacturing process, wherein the method comprises detecting a time series of sensor values by the same sensor during each of at least two executions of the manufacturing process, synchronizing the at least two time series by a method described above for synchronizing time series of sensor values relating to a manufacturing process, and recognizing anomalies in products, produced through the manufacturing process, based on the synchronized time series.

A method for recognizing anomalies in products produced through a manufacturing process is thus provided according to the present invention, which method is based on sensor time series synchronized by an improved method for synchronizing time series of sensor values relating to a manufacturing process. The method for synchronizing time series of sensor values relating to a manufacturing process in particular has the advantage that time series of sensor values relating to the manufacturing process can be synchronized in a simple and intuitive manner. In particular, the time series can be synchronized based on a non-invasive method, especially since the individual time series are only shifted by a certain value, i.e., the sensor values are hardly changed and the characteristic of the corresponding time series is substantially retained. In addition, it is not necessary to define hyperparameters or configuration parameters.

A further example embodiment of the present invention furthermore provides a system for synchronizing time series of sensor values relating to a manufacturing process, wherein the system comprises a sensor designed to detect a time series of sensor values during each of at least two executions of the manufacturing process, a synchronization unit designed to ascertain, for each of the at least two time series of sensor values, deviations of different points of the corresponding time series from corresponding points of a reference time series and to shift the corresponding time series by a value ascertained based on the ascertained deviations, in order to synchronize the time series, and a provision unit designed to provide the synchronized time series.

An improved system for synchronizing time series of sensor values relating to a manufacturing process is thus provided.

Such a system may have an advantage that time series of sensor values relating to the manufacturing process can be synchronized in a simple and intuitive manner. In particular, the time series can be synchronized based on a non-invasive method, especially since the individual time series are only shifted by a certain value, i.e., the sensor values are hardly changed and the characteristic of the corresponding time series is substantially retained. In addition, it is not necessary to define hyperparameters or configuration parameters.

According to an example embodiment of the present invention, the synchronization unit can be designed to apply a dynamic time warping algorithm in order to synchronize the time series. In this way, comparatively accurate results can be automatically achieved in a simple manner, without the need for resource-intensive adjustments.

In one example embodiment of the present invention, the system furthermore comprises an approximation unit designed to approximate the reference time series based on training data of the dynamic time warping algorithm. The reference time series can thus be derived in a simple manner based on known values, without the need for complex and resource-intensive adjustments.

However, the system furthermore comprising an approximation unit designed to approximate the reference time series based on training data of the dynamic time warping algorithm is only one possible embodiment of the present invention. Rather, the reference time series may, for example, also be defined by process experts.

Furthermore, according to an example embodiment of the present invention, the synchronization unit can be designed to disregard sensor values that are outside a specified value range. As a result, it can be ensured that the synchronization is not distorted by outliers in the sensor values and is instead based on the relevant sensor values.

In addition, according to an example embodiment of the present invention, the synchronization unit can be designed to disregard sensor values that have a distance from a corresponding point on the reference curve that is greater than a threshold value for the distance, when shifting the corresponding time series. As a result, the value by which a time series can be maximally shifted can be defined by a user and/or process expert who specifies the threshold.

A further example embodiment of the present invention also provides a system for recognizing anomalies in products produced through a manufacturing process, wherein the system comprises a sensor designed to detect a time series of sensor values during each of at least two executions of the manufacturing process, a system as described above for synchronizing time series of sensor values relating to a manufacturing process, which system is designed to synchronize the at least two detected time series, and a detection unit designed to recognize anomalies in products, produced through the manufacturing process, based on the synchronized time series.

A system for recognizing anomalies in products produced through a manufacturing process is thus provided according to the present invention, which system is based on sensor time series synchronized by an improved system for synchronizing time series of sensor values relating to a manufacturing process. The system for synchronizing time series of sensor values relating to a manufacturing process in particular has the advantage that time series of sensor values relating to the manufacturing process can be synchronized in a simple and intuitive manner. In particular, the time series can be synchronized based on a non-invasive method, especially since the individual time series are only shifted by a certain value, i.e., the sensor values are hardly changed and the characteristic of the corresponding time series is substantially retained. In addition, it is not necessary to define hyperparameters or configuration parameters.

It should be noted that the present invention provides a method for synchronizing time series of sensor values relating to a manufacturing process, which method can be used to synchronize time series of sensor values relating to the manufacturing process in a simple and intuitive manner.

The example embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a flowchart of a method for synchronizing time series of sensor values relating to a manufacturing process according to example embodiments of the present invention.

FIG. 2 is a schematic block diagram of a system for synchronizing time series of sensor values relating to a manufacturing process according to example embodiments of the present invention.

In the figures, identical reference signs denote identical or functionally identical elements, parts or components, unless stated otherwise.

### DETAILED DESCRIPTION OF EXAMPLE EMBODIMENTS

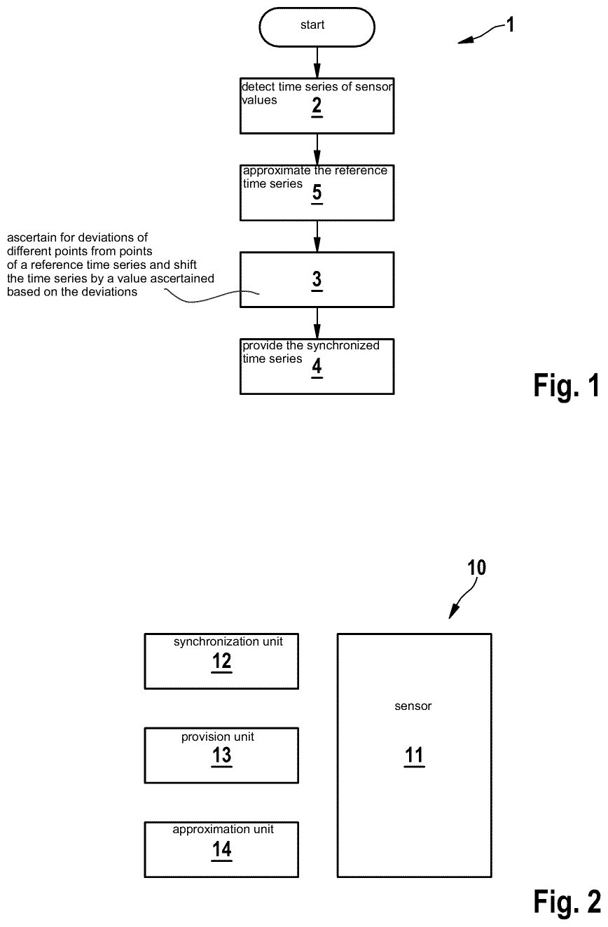

FIG. 1 is a flowchart of a method for synchronizing time series of sensor values relating to a manufacturing process 1 according to embodiments of the present invention.

As part of quality assurance during a manufacturing process, products produced through the manufacturing process are usually subjected to an inspection after the actual manufacture to check for the presence of deviations from the norm or anomalies. Based on this inspection, it can subsequently be decided, for example, whether the product in question should be further processed or used without additional effort or whether it should be scrapped or disposed of, for example in order to avoid safety risks when the object is subsequently used.

Anomalies are understood to be abnormalities or irregularities or deviations from a given norm, for example scratches on the surface of a manufactured component or unwanted gaps or openings between individual parts of the object.

Such anomalies can, for example, be identified on the basis of sensor values relating to the manufacturing process, i.e., sensor values detected during executions of the manufacturing process or the manufacture of products through the manufacturing process, or corresponding time series of sensor values, i.e., corresponding series of consecutively detected sensor values. A disadvantage, however, is that such time series of sensor values are often shifted in relation to one another, i.e., characteristic points in time during a repeatable manufacturing process may occur at different points in time in different time series of sensor values and may not be identical. Consequently, the individual time series of sensor values must be synchronized before they are evaluated, in particular before they are used for anomaly detection.

FIG. 1 shows a method 1, which comprises a step 2 of detecting a time series of sensor values by the same sensor during each of at least two executions of the manufacturing process, a step 3 of ascertaining, for each of the at least two time series of sensor values, deviations of different points of the corresponding time series from corresponding points of a reference time series and shifting the corresponding time series by a value ascertained based on the ascertained deviation, in order to synchronize the time series, and a step 4 of providing the synchronized time series.

Such a method 1 has the advantage that time series of sensor values relating to the manufacturing process can be synchronized in a simple and intuitive manner. In particular, the time series can be synchronized based on a non-invasive method, especially since the individual time series are only shifted by a certain value, i.e., the sensor values are hardly changed and the characteristic of the corresponding time series is substantially retained. In addition, it is not necessary to define hyperparameters or configuration parameters.

Overall, an improved method for synchronizing time series of sensor values relating to a manufacturing process is thus specified.

In particular, FIG. 1 shows a method in which sensor time series of which the start times are not identical are superimposed. The step 3 of ascertaining, for each of the at least two time series of sensor values, deviations of different points of the corresponding time series from corresponding points of a reference time series and shifting the corresponding time series by a value ascertained based on the ascertained deviations, in order to synchronize the time series is based, according to the embodiments of FIG. 1, on a dynamic time warping algorithm. It is possible in this case to ascertain a deviation, for each of the different points of a time series, from one or more points on the reference time series that correspond to the same point in time. Based on the distances ascertained in this way, the most frequently occurring distance can then be ascertained and the time series can be shifted to the left or right by the corresponding value in a corresponding time diagram. Subsequently, missing or required additional values of a time series can then be filled, for example by linear interpolation or a backward filling principle, in particular if the corresponding time series is shifted to the right. On the other hand, if the time series is shifted to the left, a corresponding number of initial sensor values are discarded or deleted.

In addition, separate time series of sensor values can be detected for each process step or each work procedure and synchronized accordingly. Furthermore, a user can specify a specific range in which time series are to be synchronized, wherein the method 1 is only executed for these ranges.

According to the embodiments of FIG. 1, the method also comprises a step 5 of approximating the reference time series.

In particular, the reference time series can be approximated based on training data of the corresponding dynamic time warping algorithm, for example by ascertaining the barycenter or a mean value based on a specific distance measure based on the training data.

According to the embodiments of FIG. 1, the step 3 of ascertaining, for each of the at least two time series of sensor values, deviations of different points of the corresponding time series from corresponding points of a reference time series and shifting the corresponding time series based on a value ascertained based on the ascertained deviations, comprises disregarding sensor values that are outside a specified value range.

According to the embodiments of FIG. 1, the step 3 of ascertaining, for each of the at least two time series of sensor values, deviations of different points of the corresponding time series from corresponding points of a reference time series and shifting the corresponding time series based on a value ascertained based on the ascertained deviations also comprises disregarding sensor values that have a distance from a corresponding point on the reference curve that is greater than a threshold value for the distance, when shifting the corresponding time series.

The corresponding synchronized time series can subsequently be used as the basis for further data analysis or as input data for a corresponding machine learning algorithm. In particular, the synchronized time series can form the basis for anomaly detection.

FIG. 2 is a schematic block diagram of a system for synchronizing time series of sensor values relating to a manufacturing process 10 according to embodiments of the present invention.

As shown in FIG. 2, the system 10 comprises a sensor 11 designed to detect a time series of sensor values during each of at least two executions of the manufacturing process, a synchronization unit 12 designed to ascertain, for each of the at least two time series of sensor values, deviations of different points of the corresponding time series from corresponding points of a reference time series and to shift the corresponding time series by a value ascertained based on the ascertained deviations, in order to synchronize the time series, and a provision unit 13 designed to provide the synchronized time series.

The sensor can, for example, be a temperature, pressure or vibration sensor.

Furthermore, the synchronization unit can, for example, be implemented based on code that is stored in a memory and can be executed by a processor.

The provision unit furthermore is in particular a transmitter designed to transmit corresponding data.

According to the embodiments of FIG. 2, the synchronization unit is designed to apply a dynamic time warping algorithm in order to synchronize the at least two time series of sensor values.

As FIG. 2 furthermore shows, the system 10 also comprises an approximation unit 14 designed to approximate the reference time series based on training data of the dynamic time warping algorithm.

The approximation unit can again, for example, be implemented based on code that is stored in a memory and can be executed by a processor.

According to the embodiments of FIG. 2, the synchronization unit 12 is furthermore designed to disregard sensor values that are outside a specified value range.

According to the embodiments of FIG. 2, the synchronization unit 12 is also designed to disregard sensor values that have a distance from a corresponding point on the reference curve that is greater than a threshold value for the distance, when shifting the corresponding time series.

The system 10 shown is also designed to perform a method described above for synchronizing time series of sensor values relating to a manufacturing process.

1-10. (canceled)

11. A method for synchronizing time series of sensor values relating to a manufacturing process, the method comprising the following steps:
detecting at least two time series of sensor values by the same sensor during each of at least two executions of the manufacturing process;
ascertaining, for each of the at least two time series of sensor values, deviations of different points of the time series from corresponding points of a reference time series and shifting the time series by a value ascertained based on the ascertained deviations, to synchronize the time series; and
providing the synchronized time series.

12. The method according to claim 11, wherein the step of ascertaining, for each of the at least two time series of sensor values, deviations of different points of the time series from corresponding points of a reference time series and shifting the time series by a value ascertained based on the ascertained deviations, to synchronize the time series includes applying a dynamic time warping algorithm.

13. The method according to claim 12, further comprising the following step:
approximating the reference time series based on training data of the dynamic time warping algorithm.

14. The method according to claim 11, wherein the step of ascertaining, for each of the at least two time series of sensor values, deviations of different points of the time series from corresponding points of a reference time series and shifting the c time series based on a value ascertained based on the ascertained deviations includes disregarding sensor values that are outside a specified value range.

15. The method according to claim 11, wherein the step of ascertaining, for each of the at least two time series of sensor values, deviations of different points of the time series from corresponding points of a reference time series and shifting the time series based on a value ascertained based on the ascertained deviations includes disregarding sensor values that have a distance from a corresponding point on a reference curve that is greater than a threshold value for the distance, when shifting the time series.

16. A method for recognizing anomalies in products produced through a manufacturing process, the method comprising the following steps:
detecting a time series of sensor values by the same sensor during each of at least two executions of the manufacturing process;
synchronizing the at least two time series by a method for synchronizing time series of sensor values relating to a manufacturing including:
ascertaining, for each of the at least two time series of sensor values, deviations of different points of the time series from corresponding points of a reference time series and shifting the time series by a value ascertained based on the ascertained deviations, to synchronize the time series, and
providing the synchronized time series; and
recognizing anomalies in products, produced through the manufacturing process, based on the synchronized time series.

17. A system for synchronizing time series of sensor values relating to a manufacturing process, the system comprising:
a sensor configured to detect a time series of sensor values during each of at least two executions of the manufacturing process;
a synchronization unit configured to ascertain, for each of the at least two time series of sensor values, deviations of different points of the time series from corresponding points of a reference time series and to shift the time series by a value ascertained based on the ascertained deviations, to synchronize the time series; and
a provision unit configured to provide the synchronized time series.

18. The system according to claim 17, wherein the synchronization unit is configured to apply a dynamic time warping algorithm to synchronize the time series.

19. The system according to claim 17, wherein the synchronization unit is configured to disregard sensor values that have a distance from a corresponding point on a reference curve that is greater than a threshold value for the distance, when shifting the time series.

20. A system for recognizing anomalies in products produced through a manufacturing process, the system comprising:
a sensor configured to detect a time series of sensor values during each of at least two executions of the manufacturing process;
a system for synchronizing time series of sensor values relating to a manufacturing process, wherein the system is configured to synchronize the at least two detected time series, the system for synchronizing time series of sensor values including:
a synchronization unit configured to ascertain, for each of the at least two time series of sensor values, deviations of different points of the time series from corresponding points of a reference time series and to shift the time series by a value ascertained based on the ascertained deviations, to synchronize the time series, and
a provision unit configured to provide the synchronized time series; and
a recognition unit configured to recognize anomalies in products, produced through the manufacturing process, based on the synchronized time series.
